(19) United States
(12) Patent Application Publication
(10) Pub. No.: US 2026/0177423 A1
(43) Pub. Date: Jun. 25, 2026

(54) WEARABLE DEVICE, METHOD FOR DETECTING ATTACHMENT OR DETACHMENT OF WEARABLE DEVICE, AND STORAGE MEDIUM

(71) Applicant: CASIO COMPUTER CO., LTD., Tokyo (JP)

(72) Inventors: Takeshi MIYAKE, Tokyo (JP); Keiichi NOMURA, Tokyo (JP)

(21) Appl. No.: 19/424,805

(22) Filed: Dec. 18, 2025

(30) Foreign Application Priority Data
Dec. 19, 2024 (JP) 2024-224037

(51) Int. Cl. G01J 1/42; G01P 15/00; G04G 21/02

(52) U.S. Cl. CPC G01J 1/42; G01P 15/00; G04G 21/02

(57) ABSTRACT

A wearable device that is wearable by a user includes: a plurality of light emitters; at least one light receiver; an inclination acquirer that acquires an inclination of the wearable device; and a processor. The processor: determines, based on the inclination acquired by the inclination acquirer, at least one light emitter among the plurality of light emitters as a light emitter to emit light; and determines whether the wearable device is worn by the user based on a light reception result of the light that is emitted from the determined at least one light emitter and received by the at least one light receiver.

### REFERENCE TO RELATED APPLICATIONS

This application is based upon and claims the benefit of priority from the prior Japanese Patent Application No. 2024-224037, filed on Dec. 19, 2024, the entire contents of which are incorporated herein by reference.

### TECHNICAL FIELD

The present invention relates to a wearable device, a method for detecting attachment/detachment of a wearable device, and a storage medium.

### DESCRIPTION OF RELATED ART

Conventionally, there has been disclosed a blood pressure information measurement device that is worn on an arm of a subject to measure blood pressure information of the subject (see WO 2018/142821).

### SUMMARY OF THE INVENTION

A wearable device according to the present invention is a wearable device that is wearable by a user, comprising: a plurality of light emitters; at least one light receiver; an inclination acquirer that acquires an inclination of the wearable device; and a processor, wherein the processor: determines, based on the inclination acquired by the inclination acquirer, at least one light emitter among the plurality of light emitters as a light emitter to emit light; and determines whether the wearable device is worn by the user based on a light reception result of the light that is emitted from the determined at least one light emitter and received by the at least one light receiver.

### BRIEF DESCRIPTION OF DRAWINGS

In the drawings: FIG. 1 is a diagram illustrating an external configuration of a wearable device according to an embodiment of the present disclosure;

FIG. 2 is a block diagram illustrating a functional configuration of the wearable device;

FIG. 3 is a diagram illustrating a back surface of a main body;

FIG. 4 is a flowchart illustrating an attachment/detachment detection operation control process;

FIG. 5A is a diagram illustrating a method for determining a light emitter that emits light;

FIG. 5B is a diagram illustrating the method for determining the light emitter that emits light;

FIG. 5 diagram illustrating the method for determining the light emitter that emits light;

FIG. 5D is a diagram illustrating the method for determining the light emitter that emits light;

FIG. 5E is a diagram illustrating the method for determining the light emitter that emits light;

FIG. 5F is a diagram illustrating the method for determining the light emitter that emits light;

FIG. 6A is a diagram illustrating the method for determining the light emitter that emits light;

FIG. 6B is a diagram illustrating the method for determining the light emitter that emits light;

FIG. 6C is a diagram illustrating the method for determining the light emitter that emits light;

FIG. 6D is a diagram illustrating the method for determining the light emitter that emits light;

FIG. 7A is a diagram illustrating the method for determining the light emitter that emits light;

FIG. 7B is a diagram illustrating the method for determining the light emitter that emits light;

FIG. 7C is a diagram illustrating the method for determining the light emitter that emits light;

FIG. 7D is a diagram illustrating the method for determining the light emitter that emits light;

FIG. 7E is a diagram illustrating the method for determining the light emitter that emits light; and

FIG. 7F is a diagram illustrating the method for determining the light emitter that emits light.

### DETAILED DESCRIPTION

Hereinafter, embodiments of the present invention will be described in detail with reference to the accompanying drawings. The embodiment(s) described below is provided with various limitations technically preferable for carrying out the present invention. However, the scope of the present invention is not limited to the embodiment(s) below or illustrated examples. First, an external configuration of a wearable device 1 according to the present embodiment will be described with reference to FIG. 1. As illustrated in FIG. 1, the wearable device 1 is, for example, a wristwatch, a smartwatch, an activity meter, or the like and includes a main body 2 and a band 3. The band 3 is for attaching the wearable device 1 to the arm of a user U and includes a main band (strap to be attached on the 12 o'clock side) 3a and a tip band (strap to be attached on the 6 o'clock side) 3b.

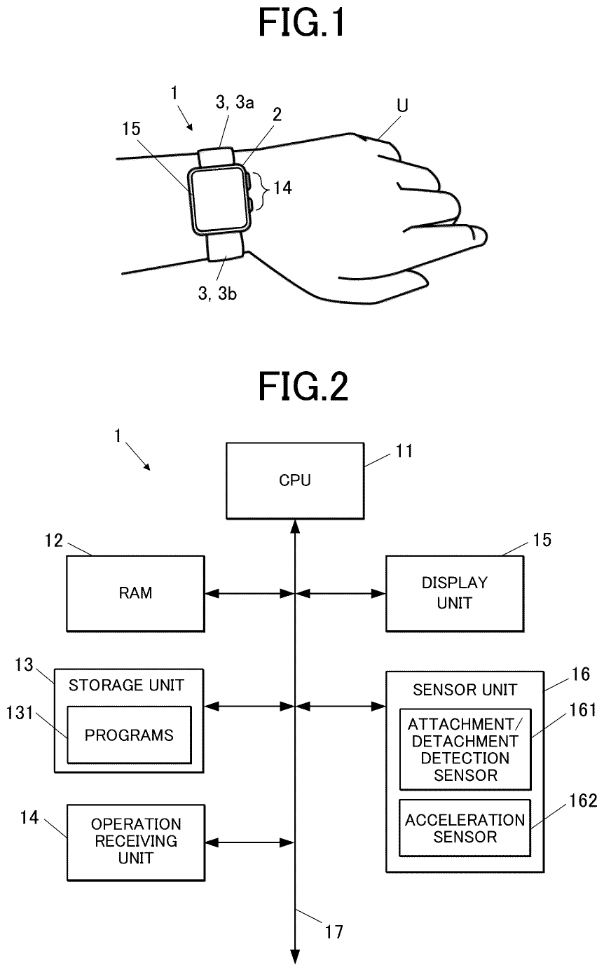

Next, a functional configuration of the wearable device 1 (main body 2) will be described with reference to FIG. 2. As illustrated in FIG. 2, the wearable device 1 includes a central processing unit (CPU) 11, a random-access memory (RAM) 12, a storage unit 13, an operation receiving unit 14, a display unit 15, and a sensor unit 16. The components of the wearable device 1 are coupled to each other via a bus 17.

The CPU (controller, processor) 11 is a hardware processor that performs arithmetic processing and comprehensively controls the overall operation of the wearable device 1. The CPU 11 may be a single processor or a plurality of processors operating in parallel. Alternatively, a plurality of independent processors may operate separately for each defined purpose. Additionally, the CPU 11 may perform operations such as counting the current date and time, enabling the display of the current time or date on a display screen of display unit 15. The RAM 12 provides a working memory space for the CPU 11 and stores temporary data. The storage unit 13 is a nonvolatile memory (e.g., flash memory). The storage unit 13 stores programs 131 and setting data. The programs 131 includes a control program related to an attachment/detachment detection operation control process described below (see FIG. 4).

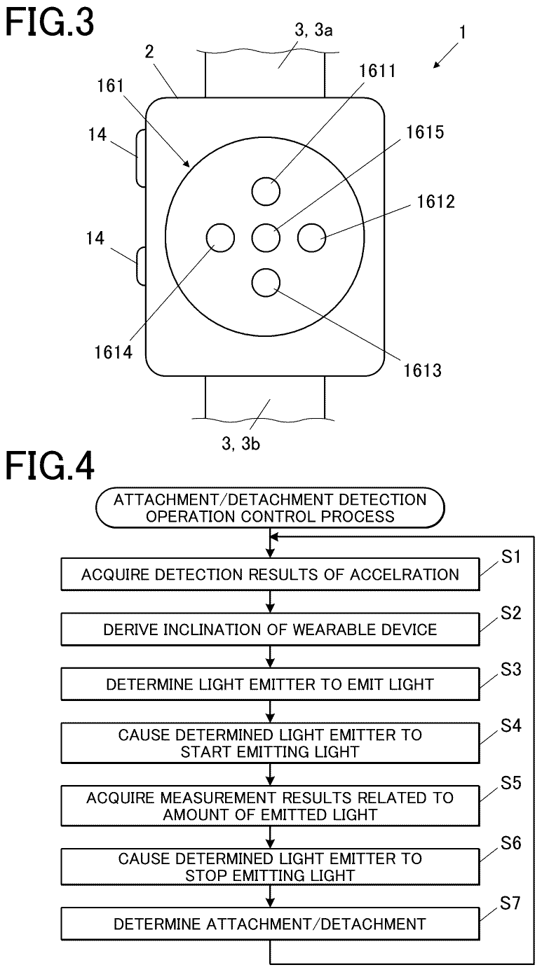

The operation receiving unit 14 (see FIGS. 1 and 3) receives an input operation from outside, such as the user U, generates an input signal, and outputs the input signal to the CPU 11. The operation receiving unit 14 includes, for example, a push-button switch. In addition to or instead of the push-button switch, the operation receiving unit 14 may include another operation receiving member, such as a touch screen positioned over the display screen of the display unit 15. The display unit 15 (see FIG. 1) performs display on the display screen under the control of the CPU 11. The display screen is, for example, but not limited to, a liquid crystal display (LCD). The display screen may be capable of displaying numbers, letters, signs, figures, images, and the like to the extent appropriate to its resolution.

The sensor unit 16 includes an attachment/detachment detection sensor 161, an acceleration sensor 162, and the like. The sensor unit 16 may further include a sensor not shown in FIG. 2. The attachment/detachment detection sensor 161 measures whether the wearable device 1 is worn on (attached to) the arm of the user U and outputs the measurement results to the CPU 11. The attachment/detachment detection sensor 161 includes a first light emitter 1611, a second light emitter 1612, a third light emitter 1613, a fourth light emitter 1614, and a light receiver 1615. The first light emitter 1611, second light emitter 1612, third light emitter 1613, and fourth light emitter 1614 are all infrared light emitting diodes (LEDs). The light receiver 1615 is a photodiode that detects light emitted from the first light emitter 1611, second light emitter 1612, third light emitter 1613, or fourth light emitter 1614 and converts the detected light into an electrical signal through the photoelectric effect.

As illustrated in FIG. 3, the light receiver 1615 is disposed at a central position of the back surface of the main body 2, that is, at a central position of a surface facing the arm of the user U when the wearable device 1 is worn. The first light emitter 1611, second light emitter 1612, third light emitter 1613, and fourth light emitter 1614 are disposed also on the back surface of the main body 2, radially and equally spaced from each other, with the light receiver 1615 at the center. Specifically, the first light emitter 1611 is disposed at the 12 o'clock position on an analog timepiece with the light receiver 1615 at the center. The second light emitter 1612 is disposed at the 3 o'clock position on an analog timepiece with the light receiver 1615 at the center. The third light emitter 1613 is disposed at the 6 o'clock position on an analog timepiece with the light receiver 1615 at the center. The fourth light emitter 1614 is disposed at the 9 o'clock position on an analog timepiece with the light receiver 1615 at the center. In other words, each of the first light emitter 1611, the second light emitter 1612, the third light emitter 1613, and the fourth light emitter 1614 is disposed at a predetermined position in the longitudinal direction of the band 3 or in a direction perpendicular to the longitudinal direction.

Here, the principle of attachment/detachment detection will be described. The attachment/detachment detection sensor 161 emits light (infrared rays) from the first light emitter 1611, second light emitter 1612, third light emitter 1613, or fourth light emitter 1614 and detects the light reflected from an object (the arm of the user) with the light receiver 1615. The amount of light detected with the light receiver 1615 is converted into an electrical signal. The presence or absence of an object (attachment or detachment) is determined based on the magnitude of the electrical signal. The attachment/detachment detection sensor 161 measures the magnitude of the electrical signal described above, i.e., measures whether the wearable device 1 is attached to the arm of the user U and outputs the measurement results (light reception results) to the CPU 11.

Returning to FIG. 2, the acceleration sensor 162 (inclination acquirer) detects the acceleration of the wearable device 1 in three orthogonal axes and outputs the detection results to the CPU 11. Based on the detection results of the acceleration sensor 162, angles (roll angle, pitch angle, and yaw angle) in the three orthogonal axes that represent the inclination of the wearable device 1 can be detected.

Next, the attachment/detachment detection operation control process executed by the wearable device 1 will be described with reference to FIG. 4. The attachment/detachment detection operation control process is executed by the CPU 11 in cooperation with the control program related to the attachment/detachment detection operation control process, which is read from the storage unit 13 and developed in the RAM 12 as appropriate. Here, the attachment/detachment detection operation control process is continuously executed, for example, triggered by the activation of the wearable device 1. When the wearable device 1 is activated, the acceleration sensor 162 is turned on. The attachment/detachment detection operation control process only needs to be ended with an interruption process in such a case as when the operation receiving unit 14 receives a predetermined operation or when the operation of the wearable device 1 is turned off.

As illustrated in FIG. 4, the CPU 11 of the wearable device 1 first acquires, from the acceleration sensor 162, the detection results of the acceleration detected by the acceleration sensor 162 (step S1). Next, the CPU 11 derives the inclination (orientation) of the wearable device 1 based on the detection results of the acceleration acquired in step S1 (step S2). Next, based on the inclination (orientation) of the wearable device 1 derived in step S2, the CPU 11 determines the light emitter that is located at the highest position (highest in the up-down (vertical) direction) among the first light emitter 1611, second light emitter 1612, third light emitter 1613, and fourth light emitter 1614 as the light emitter to emit light (step S3).

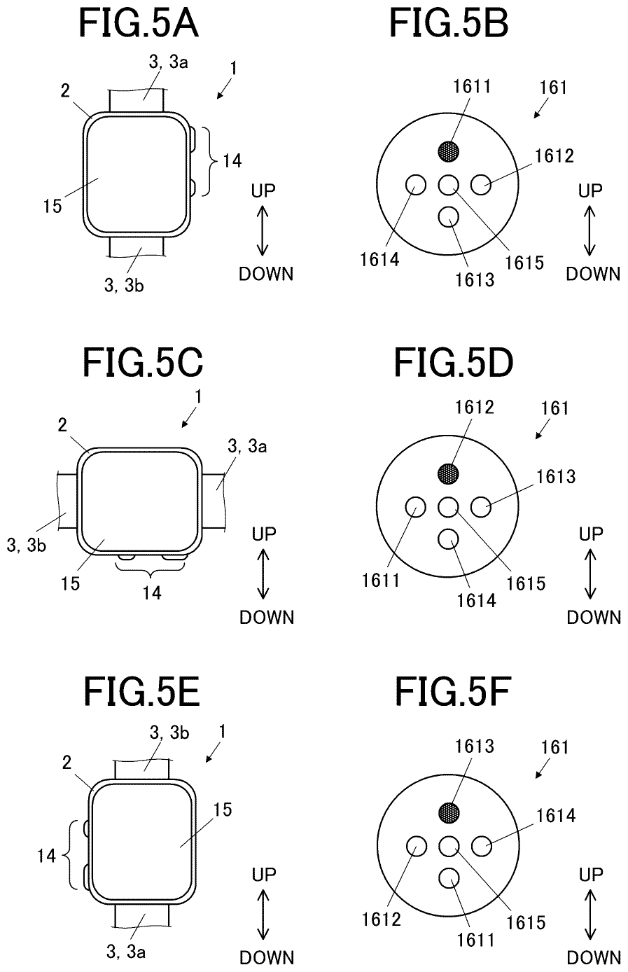

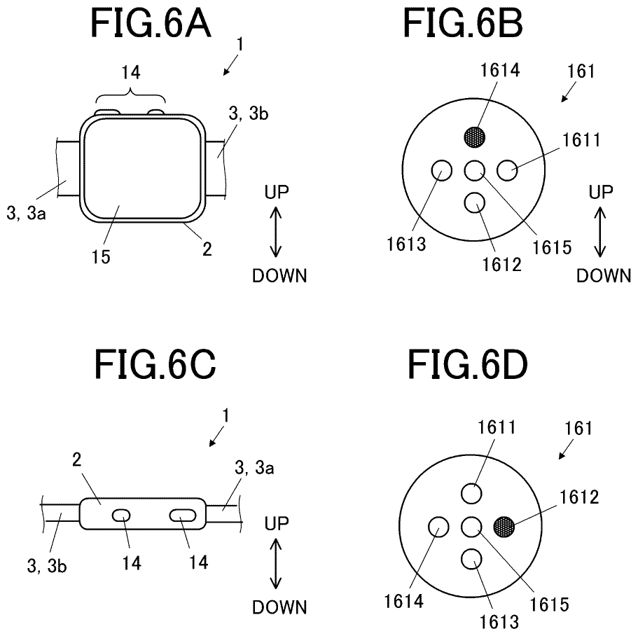

Specifically, as illustrated in FIG. 5A, when the wearable device 1 is placed on a desk or the like so that the main band 3a is positioned on the upper side in the up-down direction and the tip band 3b is positioned on the lower side, the first light emitter 1611 is located at the highest position (highest in the up-down (vertical) direction) among the first light emitter 1611, the second light emitter 1612, the third light emitter 1613, and the fourth light emitter 1614, as illustrated in FIG. 5B. Therefore, the first light emitter 1611 is determined as the light emitter to emit light. As illustrated in FIG. 5C, when the wearable device 1 is placed on a desk or the like so that the longitudinal direction of the band 3 is orthogonal to the up-down direction and the operation receiving unit 14 of the main body 2 is positioned on the lower side in the up-down direction, the second light emitter 1612 is located at the highest position (highest in the up-down (vertical) direction) among the first light emitter 1611, the second light emitter 1612, the third light emitter 1613, and the fourth light emitter 1614, as illustrated in FIG. 5D. Therefore, the second light emitter 1612 is determined as the light emitter to emit light. As illustrated in FIG. 5E, when the wearable device 1 is placed on a desk or the like so that the tip band 3b is positioned on the upper side in the up-down direction and the main band 3a is positioned on the lower side, the third light emitter 1613 is located at the highest position (highest in the up-down (vertical) direction) among the first light emitter 1611, the second light emitter 1612, the third light emitter 1613, and the fourth light emitter 1614, as illustrated in FIG. 5F. Therefore, the third light emitter 1613 is determined as the light emitter to emit light. As illustrated in FIG. 6A, when the wearable device 1 is placed on a desk or the like so that the longitudinal direction of the band 3 is orthogonal to the up-down direction and the operation receiving unit 14 of the main body 2 is positioned on the upper side in the up-down direction, the fourth light emitter 1614 is located at the highest position (highest in the up-down (vertical) direction) among the first light emitter 1611, the second light emitter 1612, the third light emitter 1613, and the fourth light emitter 1614, as illustrated in FIG. 6B. Therefore, the fourth light emitter 1614 is determined as the light emitter to emit light. As illustrated in FIG. 6C, when wearable device 1 is placed on a desk or the like so that the longitudinal direction of the band 3 is orthogonal to the up-down direction and the display screen of the display unit 15 of the main body 2 faces upward in the up-down direction, the first light emitter 1611, second light emitter 1612, third light emitter 1613 and fourth light emitter 1614 are located at the same height position in the up-down direction. In such a case, as predetermined, the second light emitter 1612 is determined as the light emitter to emit light. However, any of the light emitters may also be determined as the light emitter to emit light as long as the determined light emitter can reduce the reflection value of light that is emitted from the light emitter and reflected by the band 3, for the purpose of suppressing false detection in which the user U is determined to be wearing the wearable device 1 even though he/she is not. Therefore, the fourth light emitter 1614, which is located farther away from the band 3 than the first and third light emitters 1611 and 1613, may be determined as the light emitter to emit light.

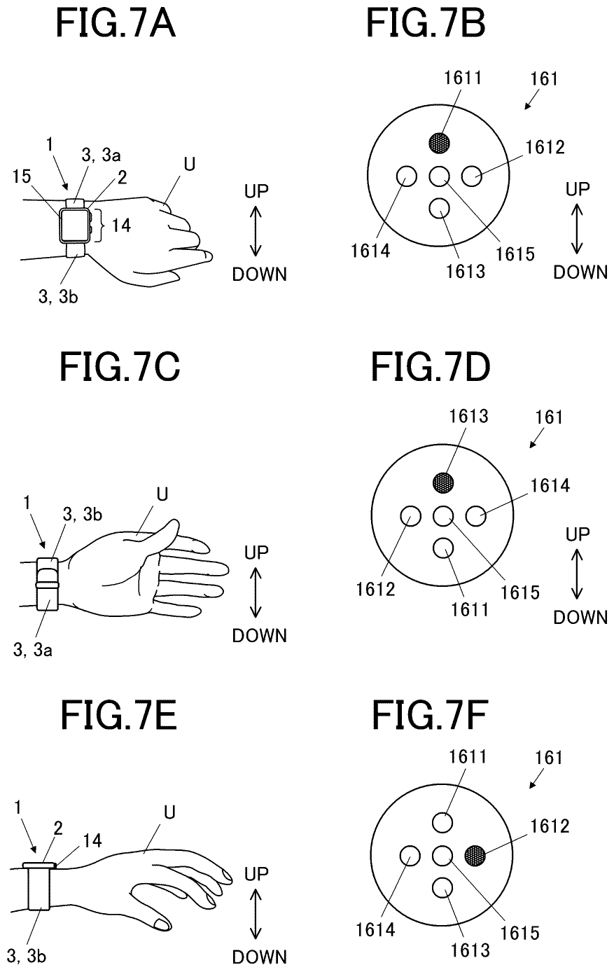

In addition, as illustrated in FIG. 7A, when the wearable device 1 is worn on the arm of the user U, and the main band 3a is located on the upper side in the up-down direction and the tip band 3b is located on the lower side, the first light emitter 1611 is located at the highest position (highest in the up-down (vertical) direction) among the first light emitter 1611, the second light emitter 1612, the third light emitter 1613, and the fourth light emitter 1614, as illustrated in FIG. 7B. Therefore, the first light emitter 1611 is determined as the light emitter to emit light. In such a case, the little finger side of the wrist is more likely to come into close contact with the main body 2 than the thumb side of the wrist due to the movement of the forearm bones (radius and ulna) of the user U. Therefore, the first light emitter 1611, which is located at a position highly likely to be in close contact with the arm of the user U, is determined as the light emitter to emit light, so that the reflection value of light that is emitted from the light emitter and reflected by the arm of the user U is not reduced. As illustrated in FIG. 7C, when the wearable device 1 is worn on the arm of the user U, and the tip band 3b is located on the upper side in the up-down direction and the main band 3a is located on the lower side, the third light emitter 1613 is located at the highest position (highest in the up-down (vertical) direction) among the first light emitter 1611, the second light emitter 1612, the third light emitter 1613, and the fourth light emitter 1614, as illustrated in FIG. 7D. Therefore, the third light emitter 1613 is determined as the light emitter to emit light. In such a case, the thumb side of the wrist is more likely to come into close contact with the main body 2 than the little finger side of the wrist due to the movement of the forearm bones (radius and ulna) of the user U. Therefore, the third light emitter 1613, which is located at a position highly likely to be in close contact with the arm of the user U, is determined as the light emitter to emit light, so that the reflection value of the light that is emitted from the light emitter and reflected by the arm of the user U is not reduced. As illustrated in FIG. 7E, when the wearable device 1 is worn on the arm of the user U and the display screen of the display unit 15 of the main body 2 is positioned to face upward in the up-down direction, the first light emitter 1611, second light emitter 1612, third light emitter 1613 and fourth light emitter 1614 are located at the same height position in the up-down direction. In such a case, as predetermined, the second light emitter 1612 is determined as the light emitter to emit light. However, any of the light emitters may also be determined as the light emitter to emit light as long as the determined light emitter can prevent the reflection value of the light that is emitted from the light emitter and reflected by the arm of the user U from being reduced, for the purpose of suppressing false detection in which the user U is determined not to be wearing the wearable device 1 even though he/she is. Therefore, the fourth light emitter 1614, which is more likely to come into close contact with the arm of the user U than the first and third light emitters 1611 and 1613, may be determined as the light emitter to emit light.

Returning to FIG. 4, next, the CPU 11 causes the light emitter determined in step S3 to start emitting light (step S4). The light emitter determined in step S3 is one of the first light emitter 1611, second light emitter 1612, third light emitter 1613, and fourth light emitter 1614, as described above. Next, the CPU 11 acquires the measurement results (light reception results) related to the magnitude of an electrical signal measured with the light receiver 1615 (step S5). This electric signal is obtained by converting the amount of light detected with the light receiver 1615, as described above. This amount of light is the amount of light that is emitted from the first light emitter 1611, second light emitter 1612, third light emitter 1613, or fourth light emitter 1614 and reflected back from an object (e.g., the arm of the user U). Next, the CPU 11 causes the light emitter determined in step S3 to stop emitting light (step S6). Next, the CPU 11 determines whether the wearable device 1 is worn on (attached to) the arm of the user U based on the measurement results obtained in step S6 (attachment/detachment determination) (step S7). Specifically, when the magnitude of the electric signal indicated by the measurement results is equal to or greater than a predetermined threshold value, the CPU 11 determines that the wearable device 1 is worn on the arm of the user U. On the other hand, when the magnitude of the above electrical signal indicated by the measurement result is less than the predetermined threshold value, the CPU 11 determines that the wearable device 1 is not worn on (detached from) the arm of the user U. Then, the CPU 11 returns the process to step S1 and repeats the subsequent processes.

In the blood pressure information measurement device disclosed in WO 2018/142821, which is a conventional technique, a pulse wave of a subject can be detected by a pulse wave detection unit having an optical sensor module including a light emitter and a light receiver. This optical sensor module is also known to be used for detecting the attachment/detachment of a wearable device on which the optical sensor module is mounted. In the above optical sensor module, when the wearable device is detached from the body (e.g., arm) of the user, depending on the orientation of the wearable device, light emitted from the light emitter may be reflected by a desk or a band attached to the wearable device. This reflected light may then be received by the light receiver. As a result, the above optical sensor module may falsely detect that a user is wearing the wearable device even though he/she is not.

In contrast, the CPU 11 of the wearable device 1: derives the inclination of the own device 1 based on the acceleration detected by the acceleration sensor 162; based on this inclination, determines at least one light emitter among the first light emitter 1611, second light emitter 1612, third light emitter 1613, and fourth light emitter 1614 (a plurality of light emitters) to emit light; and when light is emitted from the determined light emitter(s), based on the light reception results of the light received by the light receiver 1615, determines whether the own device 1 is attached to the user U. Therefore, according to the wearable device 1, when the device is not worn (see FIGS. 5A to 5F and 6A to 6D), by causing a light emitter that is located at a position as far away from a reflective object, such as the band 3 or a desk on which the wearable device 1 is placed, as possible to emit light, it is possible to reduce the reflection value of the light that is emitted from the light emitter and reflected by the reflective object. As a result, it is possible to suppress false detection in which the user U is determined to be wearing the wearable device 1 although he/she is not, thus enabling accurate detection of the attachment/detachment of the wearable device 1. In addition, according to the wearable device 1, when the device is worn (see FIGS. 7A to 7F), causing a light emitter that is located at a position highly likely to be in close contact with the arm of the user U to emit light, it is possible to prevent the reflection value of the light that is emitted from the light emitter and reflected by the arm of the user U from being reduced. As a result, it is possible to suppress false detection in which the user U is determined not to be wearing the wearable device 1 although he/she is, thus enabling the accurate detection of the attachment/detachment of the wearable device 1.

Based on the inclination of the wearable device 1, the CPU 11 determines a light emitter that is located at the highest position among the first light emitter 1611, second light emitter 1612, third light emitter 1613, and fourth light emitter 1614 as the light emitter to emit light. Therefore, according to the wearable device 1, when the device is not worn, it is possible to determine a light emitter that is located at a position as far away from a reflective object, such as the band 3 or a desk on which the wearable device 1 is placed, as possible as the light emitter to emit light. This enables the accurate detection of the attachment/detachment of the wearable device 1. In addition, according to the wearable device 1, when the device is worn, it is possible to determine a light emitter that is located at a position highly likely to be in close contact with the arm of the user U as the light emitter to emit light. This enables the accurate detection of the attachment/detachment of the wearable device 1.

The first light emitter 1611, second light emitter 1612, third light emitter 1613, and fourth light emitter 1614 are disposed on the back surface of the main body 2, radially and equally spaced from each other, with the light receiver 1615 at the center. Therefore, according to the wearable device 1, it is possible to smoothly determine the light emitter to emit light, i.e., the light emitter that is located at the highest position.

The wearable device 1 includes the band 3 for wearing the device 1 on the arm of the user U. Each of the first light emitter 1611, the second light emitter 1612, the third light emitter 1613, and the fourth light emitter 1614 is disposed at a predetermined position in the longitudinal direction of the band 3 or in the direction perpendicular to the longitudinal direction. Therefore, according to the wearable device 1, the disposition of the first light emitter 1611, the second light emitter 1612, the third light emitter 1613, and the fourth light emitter 1614 makes it difficult to have two light emitters at the highest position. This makes it possible to more smoothly determine the light emitter to emit light

The matters described in the above embodiment(s) are merely some of preferred examples of a wearable device, a method for detecting attachment/detachment of a wearable device, and a non-transitory computer-readable storage medium according to the present invention and not intended to limit the present invention. For example, in the above embodiment, a single light emitter may be disposed at the central position on the back surface of the main body 2, i.e., at the central position on the surface facing the arm of the user U when the wearable device 1 is worn, and a first light receiver, second light receiver, third light receiver, and fourth light receiver may be disposed also on the back surface of the main body 2, radially and equally spaced from each other, with the light emitter at the center. Specifically, the first light receiver is disposed at the 12 o'clock position on an analog timepiece with the light emitter at the center. The second light receiver is disposed at the 3 o'clock position on an analog timepiece with the light emitter at the center. The third light receiver is disposed at the 6 o'clock position on an analog timepiece with the light emitter at the center. The fourth light receiver is disposed at the 9 o'clock position on an analog timepiece with the light emitter at the center. In other words, each of the first light receiver, the second light receiver, the third light receiver, and the fourth light receiver is disposed at a predetermined position in the longitudinal direction of the band 3 or in the direction perpendicular to the longitudinal direction. In such a case, the CPU 11 of the wearable device 1: derives the inclination of the own device 1 based on the acceleration detected by the acceleration sensor 162; based on this inclination, determines at least one light receiver among the first light receiver, second light receiver, third light receiver, and fourth light receiver to receive light; and based on light reception results of light received by the light receiver, determines whether the own device 1 is attached to the user U.

In the above embodiment, the acceleration sensor 162 is used as the inclination acquirer according to the present invention, but another sensor may be used as the inclination acquirer as long as the inclination of the wearable device 1 can be acquired.

In the above embodiment, the attachment/detachment detection sensor 161 may be used not only to detect the attachment/detachment of the wearable device 1 but also to serve as a pulse wave sensor that measures the pulse wave of the user U, for example.

In the above description, an example has been disclosed in which a flash memory is used for the storage unit 13 as the non-transitory computer-readable storage medium according to the present invention, but the present invention is not limited thereto. As another computer-readable medium, an information recording medium such as a hard disk drive (HDD), a solid-state drive (SSD) or a CD-ROM may be applied. Further, as a medium to provide data of the programs stored in the storage medium according to the present invention via a communication line, a carrier wave can be used.

The detailed configuration and the detailed operation of each component of the wearable device 1 in the above embodiments can be appropriately changed without departing from the gist of the present invention.

1. A wearable device that is wearable by a user, comprising:
a plurality of light emitters;
at least one light receiver;
an inclination acquirer that acquires an inclination of the wearable device; and
a processor, wherein
the processor:
determines, based on the inclination acquired by the inclination acquirer, at least one light emitter among the plurality of light emitters as a light emitter to emit light; and
determines whether the wearable device is worn by the user based on a light reception result of the light that is emitted from the determined at least one light emitter and received by the at least one light receiver.

2. The wearable device according to claim 1, wherein
the inclination acquirer includes an acceleration sensor that detects an acceleration of the wearable device, and
the processor derives the inclination of the wearable device based on the acceleration detected by the acceleration sensor.

3. The wearable device according to claim 1, wherein the processor determines, based on the inclination, a light emitter that is located at a highest position in a vertical direction among the plurality of light emitters as the light emitter to emit the light.

4. The wearable device according to claim 3, wherein in a case where the wearable device is not worn by the user, the light emitter located at the highest position is a light emitter, among the plurality of light emitters, that is most likely to be located at a farthest position from a reflective object that reflects light emitted from at least one of the plurality of light emitters.

5. The wearable device according to claim 3, wherein in a case where the wearable device is worn by the user, the light emitter located at the highest position is a light emitter, among the plurality of light emitters, that is most likely to be located at a position in close contact with a body of the user.

6. The wearable device according to claim 3, wherein when the processor determines two or more light emitters as the light emitter located at the highest position, the processor further determines, among the two t or more light emitters located at the highest position, a predetermined light emitter as the light emitter to emit the light.

7. The wearable device according to claim 1, wherein the plurality of light emitters is disposed radially and equally spaced from each other with the at least one light receiver at a center.

8. The wearable device according to claim 7, further comprising a band for wearing the wearable device on an arm of the user, wherein
the plurality of light emitters includes four light emitters, and
each of the four light emitters is located at a predetermined position in a longitudinal direction of the band or in a direction perpendicular to the longitudinal direction.

9. A method for detecting attachment/detachment of a wearable device that is wearable by a user and includes:
a plurality of light emitters;
at least one light receiver;
an inclination acquirer that acquires an inclination of the wearable device; and
a processor,
the method comprising, by the processor:
determining, based on the inclination acquired by the inclination acquirer, at least one light emitter among the plurality of light emitters as a light emitter to emit light; and
determining whether the wearable device is worn by the user based on a light reception result of the light that is emitted from the determined at least one light emitter and received by the at least one light receiver.

10. The method according to claim 9, wherein
the inclination acquirer includes an acceleration sensor that detects an acceleration of the wearable device, and
the method further comprising, by the processor, deriving the inclination of the wearable device based on the acceleration detected by the acceleration sensor.

11. The method according to claim 9, wherein the method further comprising, by the processor, determining, based on the inclination, a light emitter that is located at a highest position in a vertical direction among the plurality of light emitters as the light emitter to emit the light.

12. The method according to claim 11, wherein in a case where the wearable device is not worn by the user, the light emitter located at the highest position is a light emitter, among the plurality of light emitters, that is most likely to be located at a farthest position from a reflective object that reflects light emitted from at least one of the plurality of light emitters.

13. The method according to claim 11, wherein in a case where the wearable device is worn by the user, the light emitter located at the highest position is a light emitter, among the plurality of light emitters, that is most likely to be located at a position in close contact with a body of the user.

14. The method according to claim 11, wherein when two or more light emitters are determined as the light emitter located at the highest position in the determining the light emitter located at the highest position, the method further comprising, by the processor, determining, among the two or more light emitters located at the highest position, a predetermined light emitter as the light emitter to emit the light.

15. A non-transitory computer-readable storage medium recording a program executable by a computer of a wearable device that is wearable by a user and includes:
a plurality of light emitters;
at least one light receiver;
an inclination acquirer that acquires an inclination of the wearable device; and
a processor,
the program causing the processor to:
determine, based on the inclination acquired by the inclination acquirer, at least one light emitter among the plurality of light emitters as a light emitter to emit light; and
determine whether the wearable device is worn by the user based on a light reception result of the light that is emitted from the determined at least one light emitter and received by the at least one light receiver.

16. The storage medium according to claim 15, wherein
the inclination acquirer includes an acceleration sensor that detects an acceleration of the wearable device, and
the program further causes the processor to derive the inclination of the wearable device based on the acceleration detected by the acceleration sensor.

17. The storage medium according to claim 15, wherein the program further causes the processor to determine, based on the inclination, a light emitter that is located at a highest position in a vertical direction among the plurality of light emitters as the light emitter to emit the light.

18. The storage medium according to claim 17, wherein in a case where the wearable device is not worn by the user, the light emitter located at the highest position is a light emitter, among the plurality of light emitters, that is most likely to be located at a farthest position from a reflective object that reflects light emitted from at least one of the plurality of light emitters.

19. The storage medium according to claim 17, wherein in a case where the wearable device is worn by the user, the light emitter located at the highest position is a light emitter, among the plurality of light emitters, that is most likely to be located at a position in close contact with a body of the user.

20. The storage medium according to claim 17, wherein when the processor determines two or more light emitters as the light emitter located at the highest position, the program further causes the processor to determine, among the two or more light emitters located at the highest position, a predetermined light emitter as the light emitter to emit the light.
